(19) United States
(12) Patent Application Publication
(10) Pub. No.: US 2007/0093134 A1
(43) Pub. Date: Apr. 26, 2007

(54) Fabric interconnect

(75) Inventors: George Marmaropoulos, Yorktown Heights, NY (US); Giang Vu, New York, NY (US); Mama Jack Kyriakos, London (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/560,588

(22) PCT Filed: Jun. 15, 2004
(86) PCT No.: PCT/IB04/50913

§ 371 Date: Dec. 12, 2005

Related U.S. Application Data
(60) Provisional application No. 60/479,232, filed on Jun. 17, 2003.

(51) Int. Cl. H01R 13/648

(52) U.S. Cl. 439/609

(57) ABSTRACT

There is provided a fabric interconnect comprising a portion of a garment manufactured to contain a seamless tube-like elastic chamber to enable insertion of an electronic device having a conductive portion, wherein the chamber has a first inner surface that is substantially electrically conductive and a second inner surface that is substantially electrically non-conductive, and at least one fabric electrode coupled to the first inner surface. The electronic enclosure includes an outer casing having at least one conductive area. The electronic enclosure can be aligned in the chamber to a conducting and non-conducting position, by forcing the conducting area of the electronic enclosure to be in contact with the (conductive) first inner surface of the fabric interconnect, thereby turning the electronic device “on” and “off”. For example, by rotating the electronic device within the chamber or by pushing or pulling the electronic device to a predetermined position.

The present invention relates to a fabric interconnect system. More particularly, the present invention relates to a fabric interconnect system for wearable conductive fibers in various sewn or woven fabrics used as conductive traces, bio-sensors, electrodes.

The use of integrated electronic and conductive fibers in various sewn or woven fabrics used as conductive traces, bio-sensors, electrodes, and other wearable electronic devices are well known. However, one drawback of contemporary wearable electronic applications is that some of the electronics cannot be integrated into the fabric. This is due mainly because of washability issues. For example, in the case of a Wearable Heart Rate Monitor (WHRM) device for general sport applications, the electrodes can be fully made of fabric and can be fully integrated into a garment such as a running top. The electronics though that collect the data from the electrodes and transmit them wirelessly to a watch or similar device are contained in a separate small unit which can be attached onto the garment in such a way that it can make good electrical contact with the tracking connected to the fabric electrodes. For manufacturing cost purposes it is highly desirable that the whole garment together with the electrodes, tracking and the interconnect method are all made at once in one machine in a seamless process. Thus, there is a need for a fabric interconnect without the above noted drawbacks. The preferred embodiments of the present invention fulfill this need.

It is an object of the present invention to provide an improved fabric interconnect method for attaching an electronics device, such as various wearable electronic devices and/or sensors, onto a garment with integrated fabric electrodes.

It is another object of the present invention to provide such a fabric interconnect method that ensures mechanical and electrical connection.

It is yet another object of the present invention to provide such a fabric interconnect method that enables manufacturing in a knitting machine with a minimum of post knitting interventions.

These and other objects and advantages of the present invention are achieved by a fabric interconnect comprising a portion of a garment manufactured to contain a seamless chamber to enable insertion of an electronic device having a conductive portion, wherein the chamber has a first inner surface that is substantially electrically conductive and a second inner surface that is substantially electrically non-conductive, and at least one fabric electrode coupled to the first inner surface. The electronic enclosure includes an outer casing having at least one conductive area. The electronic enclosure can be aligned in the chamber to a conducting and non-conducting position, by forcing the conducting area of the electronic enclosure to be in contact with the (conductive) first inner surface of the fabric interconnect, thereby turning the electronic device “on” and “off”. For example, by rotating the electronic device within the chamber or by pushing or pulling the electronic device to a predetermined position. Preferably, the chamber is flexible and elastic, as well as having a tube-like shape.

The present invention is more fully understood by reference to the following detailed description of a preferred embodiment in combination with the drawings identified below.

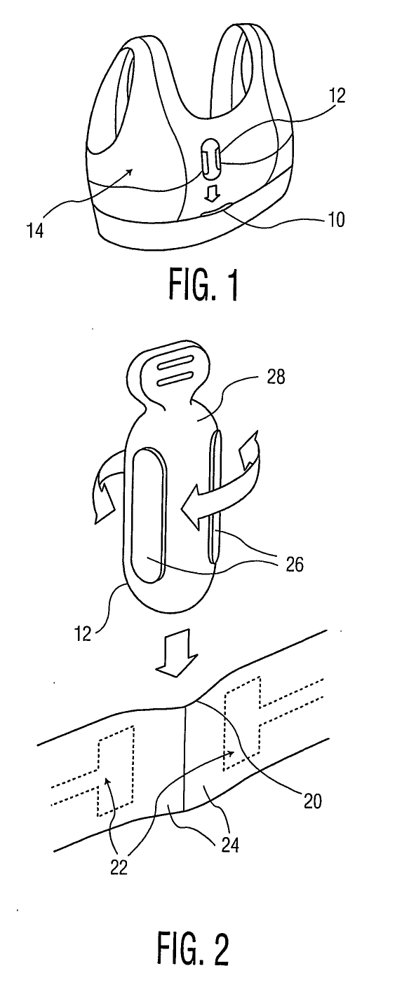

FIG. 1 is a front view of a garment with a fabric interconnect in accordance with the present invention;

FIG. 2 is a view of the fabric interconnect of FIG. 1 and an electronic device for use with the fabric interconnect;

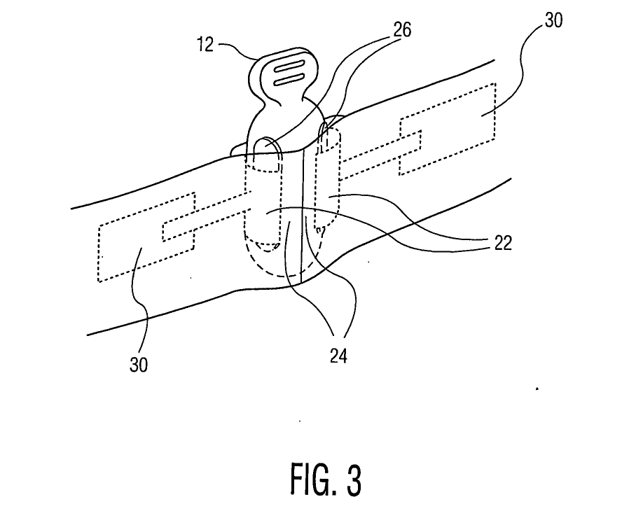

FIG. 3 is a view of the portion of the fabric interconnect of FIG. 2 with the electronic device inserted;

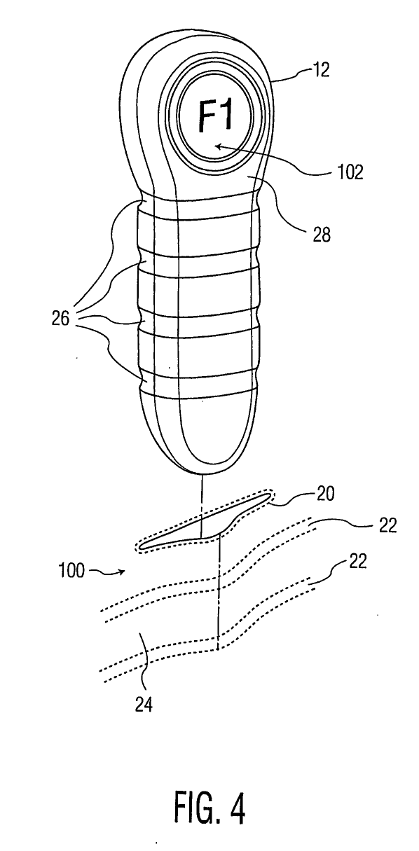

FIG. 4 is a view of an alternative embodiment of a fabric interconnect in accordance with the present invention and an electronic device for use with the fabric interconnect;

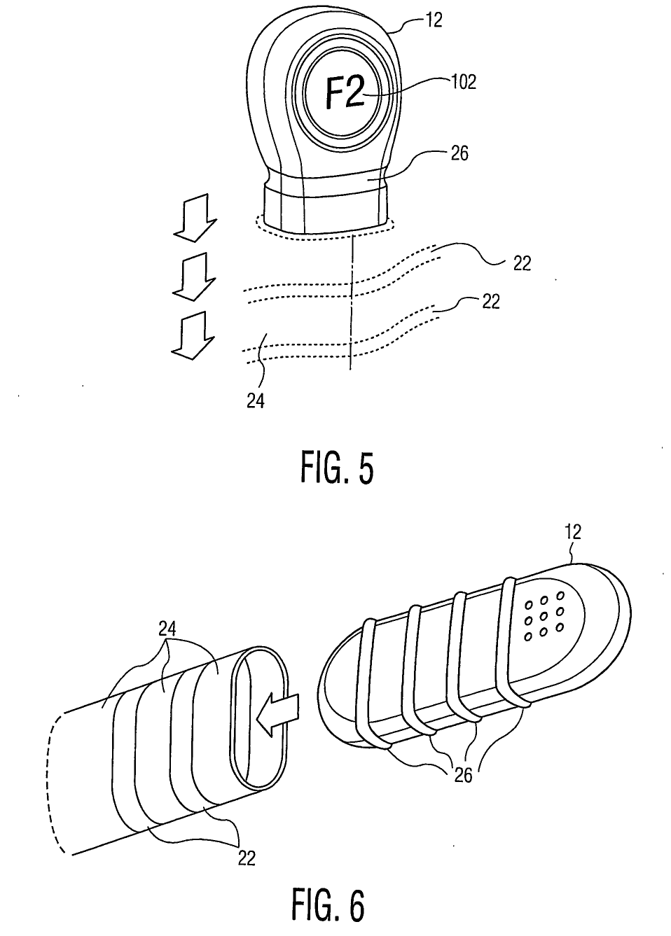

FIG. 5 is a view of the fabric interconnect of FIG. 4 with the electronic device inserted; and

FIG. 6 is a view of an other alternative embodiment of a fabric interconnect in accordance with the present invention and an electronic device for use with the fabric interconnect.

Referring to the drawings and, in particular, FIG. 1, there is shown an improved fabric interconnect in accordance with the present invention generally represented by reference numeral 10. The present invention enables an electronics enclosure 12, for example, of a Heart Rate Monitor (HRM), to be attached onto a garment 14 with fabric electrodes. FIG. 2 is a view of the fabric interconnect of FIG. 1 and electronic enclosure 12 for use with the fabric interconnect. FIG. 3 is a view of the portion of the fabric interconnect of FIG. 2 with electronic enclosure 12 inserted.

Referring to FIGS. 1, 2 and 3, fabric interconnect 10 comprises a portion of garment 14 having a seamless chamber 20 formed by a first inner surface 22 and a second inner surface 24. First inner surface 22 is substantially electrically conductive. Second inner surface 24 is substantially electrically non-conductive. In addition, at least one fabric electrode 30 is coupled to the conductive portion (first inner surface 24) of chamber 20.

Advantageously, manufacturing costs are reduced, since the entire garment together with the electrodes, tracking and the interconnect method are all made at once in one machine in a seamless process. An example of such a machine is the santoni circular knitting machine.

Fabric interconnect 10 includes a seamless tube or chamber having a substantially tubular/oval shape. However, alternative shapes for fabric interconnect 10 can also be used including circular or square. Preferably, fabric interconnect 10 is made of a material with elasticity.

Electronic enclosure 12 includes a casing 28 that has conductive areas 26. For example, casing 28 may be made of any conventional material such as plastic and conductive areas 26 may be made of conductive carbonized plastic. Conductive areas 26 are internally connected to, and part of, an electronics circuit (not shown) inside the enclosure, which requires selective opening and closing of the connection with the electrodes 22 of garment 14. As noted above the chamber or tube has an opening (which is post knitting intervention) that allows the insertion of electronics enclosure 12 into the chamber.

Electronic enclosure 12 can be aligned in the chamber to a conducting and non-conducting position, thereby turning the electronic device “on” and “off”. For example, by rotating electronic enclosure 12 within the chamber a user can bring the conductive areas of the inner portion of the chamber in contact with the outer conductive surface area of the electronic device and therefore switch the electronic device on. In a similar manner the electronic enclosure 12 may be inserted into the chamber but be switched off by being rotated so that there is no electrical contact between respective conductive portions or areas.

In this embodiment, elasticity of the fabric interconnect walls of the chamber provides the necessary force to keep the electronic device in the chamber as well as the force to keep a good electrical contact between the respective conductive areas. However, as one skilled in the art will recognize, other methods by be utilized, such as a fabric latch or button may be sewn into the garment.

Referring to FIG. 3, fabric interconnect 10 is shown with the insertion of electronic enclosure 12. The insertion of electronic enclosure 12 enables the conductive area 26 of the electronic device to be in contact with the conductive first inner surface 22 of fabric interconnect 10. The contact of conductive area 26 and first inner surface 22 forms an interconnection.

Referring to FIGS. 4-6, there is shown an alternative embodiment of a fabric interconnect in accordance with the present invention and an electronic device for use with the fabric interconnect, generally represented by reference numeral 100. Fabric interconnect 100 includes at least two conductive inner surfaces, as will be discussed later in detail. Features common to both the embodiments of fabric interconnect 10 and 100 are denoted with the same reference numbers.

Referring to FIGS. 4-6, fabric interconnect 100 comprises a portion of garment 14 having a chamber 20 formed by a plurality of first inner surfaces 22 and a plurality of second inner surfaces 24. First inner surfaces 22 are substantially electrically conductive. Second inner surfaces 24 are substantially electrically non-conductive. In addition, at least one fabric electrode 30 (not shown) is coupled to the conductive portion (first inner surfaces 24) of chamber 20.

Fabric interconnect 100 is a seamless tube or chamber having a substantially tubular/oval shape. However, alternative shapes for fabric interconnect 100 can also be used including circular or square. Preferably, fabric interconnect 100 is made of a material with elasticity.

Electronic enclosure 12 includes a casing 28 that has conductive areas 26 and a display device 102, such as an LCD. Casing 28 may be made of any conventional material such as plastic and conductive areas 26 may be made of conductive carbonized plastic. Conductive areas 26 are internally connected to, and part of, an electronics circuit (not shown) inside the enclosure, which requires selective opening and closing of the connection with the electrodes 22 of garment 14. As noted above the chamber or tube has an opening (which is post knitting intervention) that allows the insertion of electronics enclosure 12 into the chamber.

Electronic enclosure 12 can be aligned in the chamber to a plurality of positions, thereby enabling the electronic device to introduce different functionalities. For example, by pushing or pulling electronic enclosure 12 within the chamber a user can bring the one or more conductive areas of the first inner surface 22 of the chamber in contact with the outer conductive surface area 26 of the electronic device. Accordingly, a user can select different functionalities corresponding to the various positions, by inserting the electronic device further or less into the chamber. An indication of the different functionalities is displayed on display device 102.

Referring to FIG. 5, fabric interconnect 100 is shown with the insertion of electronic enclosure 12. The insertion of electronic enclosure 12 enables the conductive area 26 of the electronic device to be in contact with the conductive first inner surface 22 of fabric interconnect 10. The contact of conductive area 26 and first inner surface 22 forms an interconnection.

The present invention having been thus described with particular reference to the preferred forms thereof, it will be obvious that various changes and modifications may be made therein without departing from the spirit and scope of the present invention as defined in the appended claims.

What is claimed is:

1. A fabric interconnect (10) for use to interconnect a garment (14) having fabric electrodes (30) and an electronics enclosure (12) having a conductive area (26) on its outer surface (28) that is connected to a circuit, said fabric interconnect (12) comprising:
a portion of the garment (14) including
a first inner surface (22), which is substantially electrically conductive, coupled to the fabric electrodes (30); and
a second inner surface (24) that is substantially electrically non-conductive,
wherein the first inner surface (22) and the second inner surface (24) are seamlessly manufactured to form a chamber, and wherein when the electronics enclosure (12) is inserted into the chamber in a predetermined position, causes the conductive area (26) of the electronics enclosure (12) and the first inner surface (22) to make contact and form an interconnection between the fabric electrodes (30) of the garment (14) and the circuit.

2. The fabric interconnect (10) of claim 1, wherein a force is applied to the chamber to position the electronics enclosure (12) to the predetermined position.

3. The fabric interconnect (10) of claim 1, wherein a force is applied to the electronics enclosure (12) to position the electronics enclosure (12) to the predetermined position.

4. The fabric interconnect (10) of claim 1, wherein the first (22) and second (24) inner surfaces are flexible.

5. The fabric interconnect (10) of claim 1, wherein the first and second inner surfaces are elastic.

6. The fabric interconnect (10) of claim 1, wherein the chamber has a tube-like shape.

7. The fabric interconnect (10) of claim 3, wherein the force is a rotating force.

8. The fabric interconnect (10) of claim 3, wherein the force is an insertion or retraction force between the electronics enclosure (12) and the seamless chamber.

9. The fabric interconnect (10) of claim 1, wherein the first inner surface (22) is a plurality of first inner surface (22), the second inner surface is a plurality of second inner surfaces (24) and each of the plurality of first inner surface (22) is aligned with one of the plurality of second inner surfaces (24).

10. The fabric interconnect (10) of claim 1, wherein the electronics enclosure is a portion of a Heart Rate Monitor.

11. An electronics enclosure (12) for use with a fabric interconnect (10) in a garment (14) having fabric electrodes (30), said electronics enclosure (12) comprising:
a casing (28) including a substantially electrically conductive area (26); and
a circuit coupled to the conductive area,
wherein the conductive area (26) is configured to be inserted into a seamless chamber of the fabric interconnect (10), in a predetermined position, and causes the conductive area of the electronics enclosure (12) and a conductive inner surface (22) of the seamless chamber of the fabric interconnect (10) to make contact and form an interconnection between the fabric electrodes (30) of the garment (14) and the circuit.

12. The electronics enclosure (12) of claim 10, further including an indicator (102) to indicate a functionality of the electronics enclosure (12).

13. The electronics enclosure (12) of claim 10, wherein the indicator (102) is a display (102).

14. The electronics enclosure (12) of claim 10, wherein the electrically conductive area (26) is a plurality of electrically conductive areas (26), and further including a plurality of electrically non-conductive areas on the casing (28) and each of the plurality of electrically conductive areas (26) is aligned with one of the plurality of electrically non-conductive areas.

15. The electronics enclosure (12) of claim 13, wherein the functionality of the electronics enclosure (12) corresponds to a predetermined position in the seamless chamber.

16. The electronics enclosure (12) of claim 15, wherein conductive inner surface (22) of the seamless chamber is a plurality conductive inner surfaces (22), and the seamless chamber further includes a plurality of non-conductive inner surfaces (26) and each of the plurality of conductive inner surface (22) is aligned with one of the plurality of non-conductive inner surface (26).

17. The electronics enclosure (12) of claim 15, wherein the functionality of the electronics enclosure (12) corresponds to a predetermined number of conductive inner surfaces (22) of the seamless chamber in contact with predetermined number of electrically conductive areas (26) of the electronics enclosure (92).
